(19) United States
(12) Patent Application Publication
(10) Pub. No.: US 2008/0152182 A1
(43) Pub. Date: Jun. 26, 2008

(54) Headset with interchangeable ear pieces

(76) Inventors: Joeben Bevirt, Santa Cruz, CA (US); David Eliot Scheinman, Woodside, CA (US); Fred Italo Polito, Santa Cruz, CA (US)

Correspondence Address: MICHAEL A. GUTH, 2-2905 EAST CLIFF DRIVE, SANTA CRUZ, CA, 95062, US

(21) Appl. No.: 11/650,302

(22) Filed: Jan. 5, 2007

Related U.S. Application Data
(63) Continuation-in-part of application No. 11/488,957, filed on Jul. 19, 2006.
(60) Provisional application No. 60/849,554, filed on Oct. 4, 2006.

(51) Int. Cl. H04R 21/00

(52) U.S. Cl. 381/371

(57) ABSTRACT

A headset with removable ear pieces such that a user may interchange between ear gels and mushroom type ear pieces, or other pieces. The earpieces may be removably attached to the headset using a circular snap in some embodiments. An ear gel consisting of two types of elastomer of differing hardness, allowing for a soft elastomer to be in contact with the user's ear, giving greater comfort and better fit, the soft elastomer overmolded onto a firmer elastomer used to snap to the headset.

### CROSS-REFERENCE TO RELATED APPLICATIONS

This application is a continuation-in-part of U.S. patent application No. 11/488,957 to Bevirt et al., filed Jul. 19, 2006, which is hereby incorporated by reference in its entirety. This application also claims priority to U.S. Provisional Patent Application No. 60/849,554, filed Oct. 4, 2006, to Bevirt et al.

### BACKGROUND

1. Field of the Invention

This invention relates to headsets, and more specifically to headsets with differing types of earpieces.

2. Description of Related Art

Personal two way communications devices are becoming ever more popular. The use of cellular telephones is becoming more and more a part of everyday life, and the use of cordless telephone devices continues to increase. Also, the introduction of family radio services two way radios into the market place has greatly increased the popularity and usage of two way radios.

It has long been known in the industry to use a headset for receiving sound from such two way communications devices. Such headsets may contain small speakers placed on or near one or both ears of the user for allowing the user to hear audio signals produced by the communications device. Such headsets may be used with a separate detached microphone, or may be used with a microphone attached thereto. The most common configuration for attached microphones is to place the microphone on a boom arm such that the microphone is near the mouth of the user. However, other configurations are known in the art, such as placing the microphone on a cord hanging from the speaker portion, or otherwise connecting the microphone to the headset mechanism.

While many of the prior art headset devices have adequately produced sound to the user and received sound which is produced by the user, anyone who has used such devices knows that the ideal solution has yet to be produced in the prior art. Among the problems that have existed in the prior art are the fact that the sound producing devices of the headset often completely occlude the ear or ears of the user, thus inhibiting the user from hearing outside sounds. This can be inconvenient in certain situations. Another problem is that there can be cross talk between the speakers and the microphone. This is a particular problem where the speaker devices are non-occluding. In such arrangements the amount of sound escaping from the speaker devices is often sufficiently great that it can be picked up by the microphone.

An additional problem with prior art devices is that while a user may select a headset based on its technical specifications, it may be limited in the size and type of earpiece that it is equipped with. Some users may want to use an earpiece of a particular type, size, shape, or softness, and they may also want to vary between types of earpieces depending upon the operating environment in which they are using the headset. Thus, a user may desire to have higher quality sound and to hear less background noise, yet in other situations may desire to hear more of their environment. One type of earpiece may provide more outside sound isolation and another may provide less outside sound isolation. Prior art devices have required the user to settle on a pre-determined balance of these factors. A headset which allows for the switching of earpieces of differing types would present a distinct improvement over the prior art. A user may select the earpiece best suited to their need while having needed to purchase only a single headset.

What is needed is a headset that allows for the easy removal and replacement of earpieces such that differing types and sizes of earpieces, such as gel caps and mushroom caps, can be selected and installed by the user. What is also needed is a gel cap earpiece which is both soft and able to be removed and replaced.

### SUMMARY

A headset with easily removable and replaceable ear pieces such that a user may interchange between ear gels and mushroom type ear pieces, or other pieces. The earpieces may be removably attached to the headset using a circular snap in some embodiments. An ear gel consisting of two types of elastomer of differing hardness, allowing for a soft elastomer to be in contact with the user's ear, giving greater comfort and better fit, the soft elastomer overmolded onto a firmer elastomer used to snap to the headset.

### BRIEF DESCRIPTION OF THE DRAWINGS

FIG. 1 illustrates a headset according to some embodiments of the present invention.

FIG. 2 illustrates a headset according to some embodiments of the present invention.

FIG. 3 illustrates an ear engaging body and speaker cap according to some embodiments of the present invention.

FIG. 4 illustrates an ear engaging body and speaker cap according to some embodiments of the present invention.

FIG. 5 is an exploded view of an earpiece according to some embodiments of the present invention.

FIG. 6 is a cross-sectional view of an earpiece according to some embodiments of the present invention.

FIG. 7 is an exploded view of an earpiece according to some embodiments of the present invention.

FIG. 8 is a cross-sectional view of an earpiece according to some embodiments of the present invention.

FIG. 9 is a sketch of an ear listing portions of the ear.

FIGS. 10A-E are views of an ear engaging body according to some embodiments of the present invention.

FIG. 11 illustrates an ear and headset according to some embodiments of the present invention.

FIG. 12 illustrates an ear and headset according to some embodiments of the present invention.

FIG. 13 illustrates an ear and headset according to some embodiments of the present invention.

FIGS. 14A-C illustrate a speaker cap and a speaker cap with differing ear engaging bodies.

FIGS. 15A-E illustrate an ear engaging body according to some embodiments of the present invention.

FIG. 16A-C illustrates an ear and headset according to some embodiments of the present invention.

### DETAILED DESCRIPTION

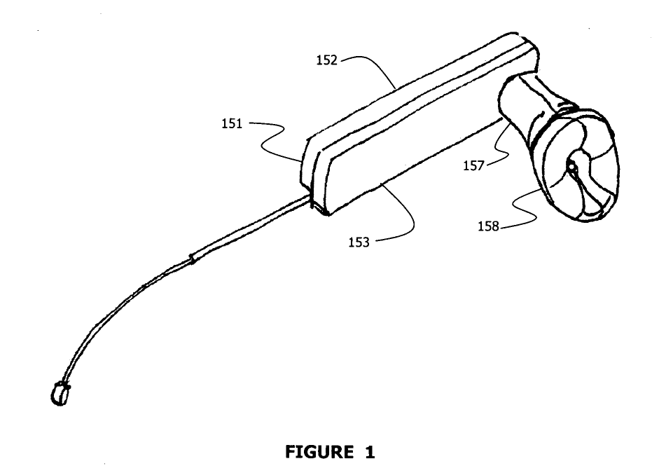

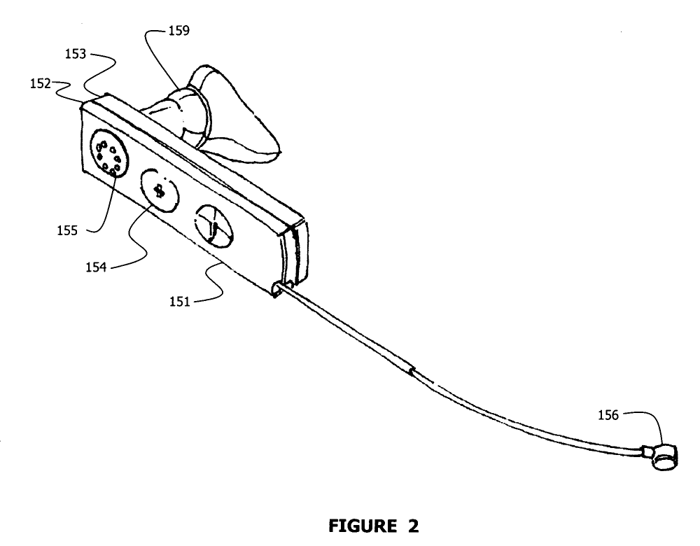

FIGS. 1 and 2 illustrate a headset according to some embodiments of the present invention. The main body 151 may consist of an inner housing 153 and an outer housing 152. An earpiece 159 is attached to the main body 151. One or more buttons 151, 154 may be positioned on the outer housing 152 of the main body 151 and may be used to implement functionalities of the headset 150. An LED panel 155 may indicate function. A microphone 156 is seen. The main body may contain the electronics for the headset or wireless headset.

In some embodiments, the microphone may be a deployable microphone that deploys with the use of a microphone boom. The microphone boom may be stowed into the main body 151. Although the present invention has been disclosed using embodiments of wireless headsets, other types of headsets including wired headsets may be utilized in other embodiments.

Referring to FIGS. 1 and 2, the earpiece 159 consists of an earpiece base 157 and an ear engaging body 158. The earpiece 159 may be attached to the main body 151 with a flexible joint. The flexible joint may allow the relative position and angle of the main body of the headset and the earpiece to be adapted for users with differing ear shapes and geometries. The ear engaging body 158 may be adapted to fit into the ear canal of the user, and may be adapted to support the headset on the user's head without additional attachments in some embodiments.

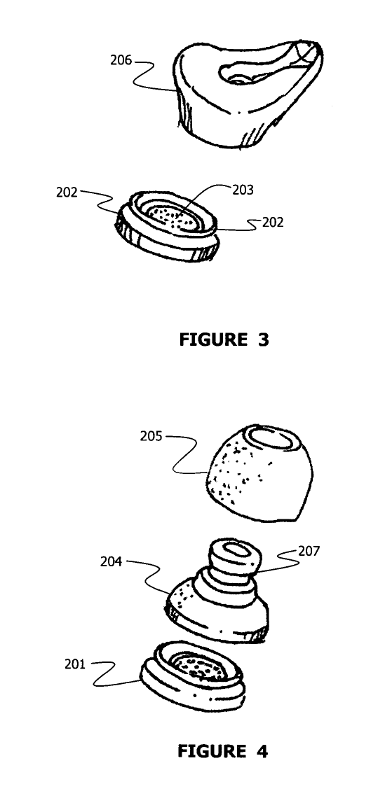

FIGS. 3 and 4 illustrate aspects of removable and interchangeable ear engaging bodies according to some aspects of the present invention. In FIG. 3, a gel cap 206 is seen in exploded view with a speaker cap 201. The gel cap 206 may be made of an elastomer with a hardness of shore A40-50 durometer. The speaker cap 201 provides the interface portion of the earpiece base to the gel cap 206. The speaker cap 201 is seen with holes 203 which allow for the transmission of sound through the speaker cap 201. A grip rim 202 presents a raised rim to which the gel cap 206 is removably attached to the speaker cap and thus the earpiece base. The gel cap 206 has an inner recess adapted to engage the grip rim 202. The elastomer of the gel cap 206 is soft enough stretch over the grip rim as it is attached to the grip rim, yet stiff enough to remain affixed with the forces encountered with typical use of the headset, including the support of the headset by the ear via the gel cap. The removable nature of the gel cap 206 allows the user to substitute a cap of a size or shape more suited for the particular geometry of the user, or of a differing type of construction that may enhance or limit the ability of the ear in use to hear other sounds, or of a different hardness more suited to the comfort of the user. A gel cap typically does not seal the ear canal of the user. The user may prefer this type of ear engaging body, trading off the somewhat reduced sound quality for other concerns. Although some users may actually received an enhanced sound quality with a leaky gel cap. For those users, the sealed ear bud may create a diminished sound.

In some embodiments of the present invention, as seen in exploded view in FIG. 4, a mushroom cap 200 is shown. The mushroom cap 200 is a different type of ear engaging body from the gel cap shown in FIG. 3. The mushroom cap 200 includes a circular cap 205 mounted onto a pyramid base 204 which is then removably attached to the speaker cap 201. A flange 207 on the pyramid base 204 is inserted into a mating feature on the underside of the mushroom cap 205 to attach the two pieces. The mushroom cap 200 typically substantially seals off the ear canal of the user. This results in reduced outside noise and enhanced sound quality.

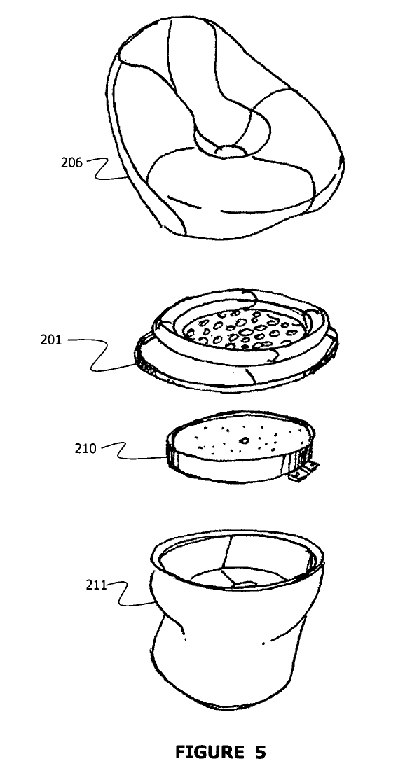

FIG. 5 illustrates an exploded view of an earpiece according to some embodiments of the present invention. An earpiece base 211 provides a cavity and enclosure for the speaker 210. The speaker cap 201 is affixed to the earpiece base 211 and covers and protects the speaker 210, which sits in a well 221 within the top of the earpiece base 211. A gel cap 206 is removably attached to the speaker cap 201, which is affixed to the earpiece base 211. In some embodiments, the earpiece base is connected to the main body of the headset with a flexible joint. In some embodiments, the flexible joint is a ball and socket joint. In some embodiments, the speaker may be on the main body side of the flexible joint and the sound may be channeled through the joint to the ear of the user. In some embodiments, the grip rim may be mounted on the headset, and the ear engaging bodies may be thus directly mounted to the headset.

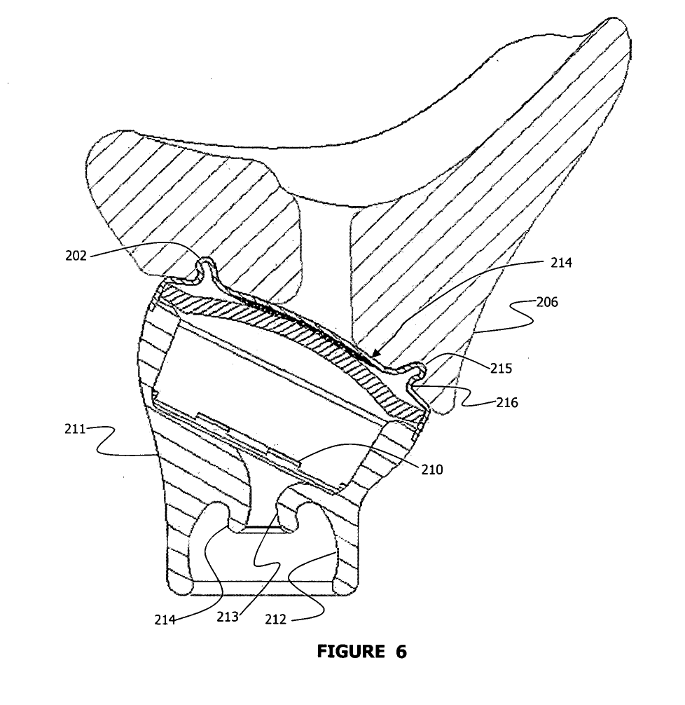

FIG. 6 is a cross-sectional view of an earpiece according to some embodiments of the present invention. The earpiece base 211 is seen with a socket receiving cavity 212 adapted to receive a socket to form a flexible joint with the main body of the headset. An internal lip 214 is adapted to function as a mechanical stop to prevent over-rotation of the socket, which may be hollowed out to allow the internal lip 214 to reside within the hollow, thus allowing only a predetermined range of rotation. A hole 213 through the base 211 allows for the routing of wires to a speaker (or other type of audio driver). In some embodiments, the speaker may be on the headset side of the joint, and the hole 213 may be adapted to channel sound across the joint. A speaker 210 resides within a cavity in the upper portion of the earpiece base 211. The speaker cap 201 is attached to the earpiece base 211, and provides both a physical interface to the ear engaging body, as well as a protective cover for the speaker. The gel cap 206 has a recess 215 adapted to engage the grip rim 202, and an extension 216 adapted to clip under the grip rim 202. Although a circular profile is illustrated, other shapes may be used. The bottom surface 214 of the gel cap 206 may overlay in part the top of the speaker cap 201 in some embodiments. A through channel 222 is adapted to channel sound through the gel bud 206. In some embodiments, the gel cap 206 is of a TPE material, with a durometer of shoreA 10-50. In some embodiments, the gel cap 206 is of a TPE material, with a durometer of shore 25.

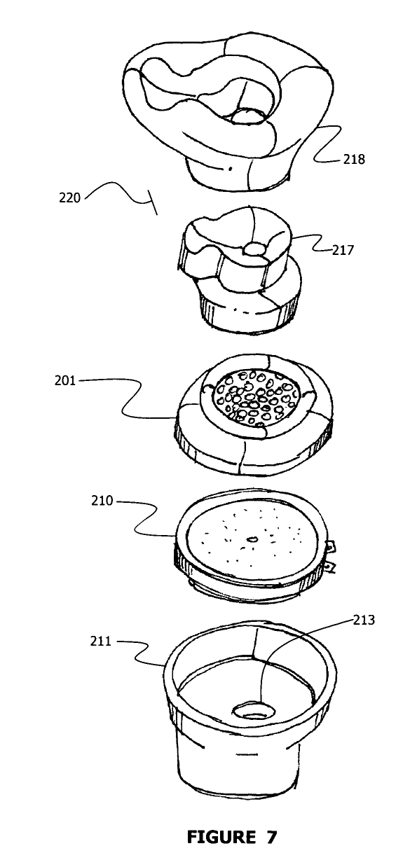

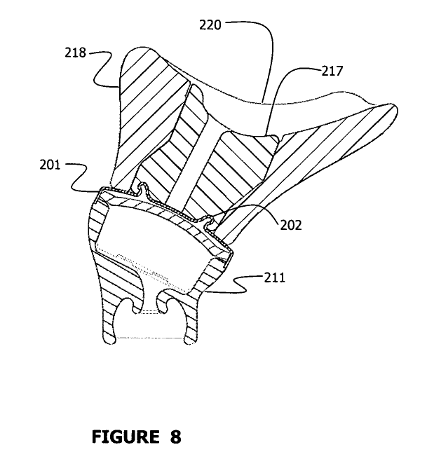

FIG. 7 illustrates an exploded view of an earpiece according to some embodiments of the present invention. An earpiece base 211 provides a cavity and enclosure for the speaker 210. The speaker cap 201 is affixed to the earpiece base 211 and covers and protects the speaker 210, which sits in a well 221 within the top of the earpiece base 211. A gel cap 220 is removably attached to the speaker cap 201, which is affixed to the earpiece base 211. In some embodiments, the earpiece base is connected to the main body of the headset with a flexible joint. In some embodiments, the flexible joint is a ball and socket joint. In some embodiments, the speaker may be on the main body side of the flexible joint and the sound may be channeled through the joint to the ear of the user. In some embodiments, the grip rim may be mounted on the headset, and the ear engaging bodies may be thus directly mounted to the headset.

The gel cap 220 has an outer section 218 and an inner section 217. The use of a two or multi part gel cap allows for a softer, potentially much more versatile and comfortable, gel cap. The outer section 218 may be of softer material, such as a TPE with shoreA 10-25 durometer. The inner section 217 may be of a somewhat firmer material, such as a TPE with shoreA 40-50. The softer outer section may be adapted for the comfort and fit of the user. The firmer inner section allows for sufficient rigidity such that the gel cap can be snapped on and off of the earpiece base, and of sufficient rigidity to stay snapped onto the earpiece base, when used in an interchangeable scenario according to some embodiments of the present invention. The gel cap 218 may be manufactured using an overmolding process that results in a unitary piece with the two materials as shown.

FIG. 8 is a cross-sectional view of an earpiece according to some embodiments of the present invention. The earpiece base 211 is seen with a socket receiving cavity 212 to receive a socket to form a flexible joint with the main body of the headset. In some embodiments, the speaker may be on the headset side of the joint. A speaker resides within a cavity in the upper portion of the earpiece base 211. The speaker cap 201 is attached to the earpiece base 211, and provides both a physical interface to the ear engaging body, as well as a protective cover for the speaker. The gel cap 220 has a recess adapted to engage the grip rim 202, and an extension adapted to clip under the grip rim 202. The bottom surface of the gel cap 220 may overlay in part the top of the speaker cap 201 in some embodiments. A through channel is adapted to channel sound through the gel cap 220. In some embodiments, the gel cap 220 is of two types of TPE material. The outer section 218 may be of a first material, and the inner section 217 may be of a second material. The outer section 218 may be of softer material, such as a TPE with shoreA 10-25 durometer. The inner section 217 may be of a somewhat firmer material, such as a TPE with shoreA 40-50. The softer outer section may be adapted for the comfort and fit of the user. The firmer inner section allows for sufficient rigidity such that the gel cap can be snapped on and off of the earpiece base, and of sufficient rigidity to stay snapped onto the earpiece base, when used in an interchangeable scenario according to some embodiments of the present invention.

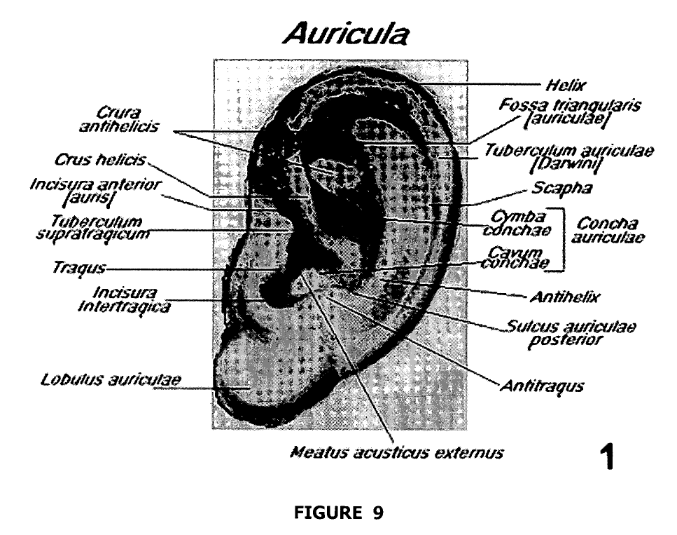

FIG. 9 is a sketch of a human ear with numerous of its features labeled. This sketch helps the reader to understand some of the terms used below.

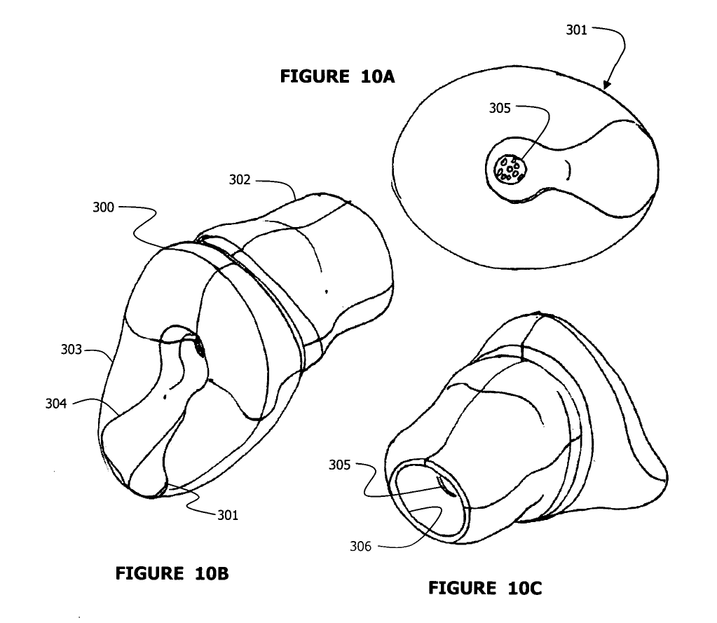

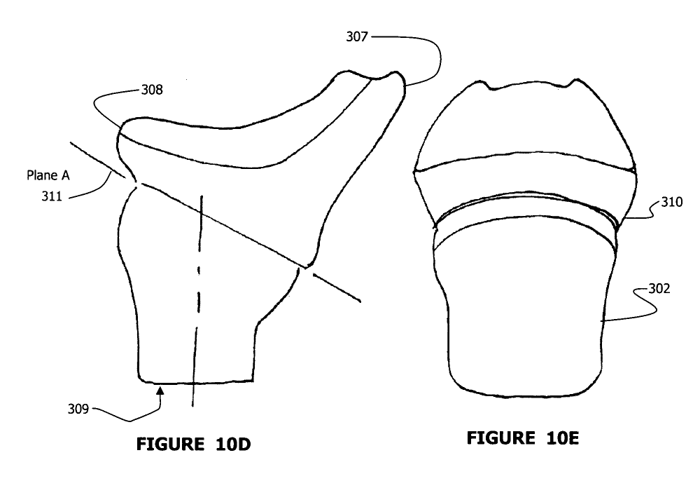

FIGS. 10A-E illustrate a gel cap 300 according to some embodiments of the present invention. The gel cap 300 is an ear engaging body adapted to be removably attached to an ear piece base as described above. As seen in FIG. 10A, the gel cap may be of an elliptical shape 301. The view of FIG. 10A is a top view down parallel to Plane A of FIG. 10D. The gel cap 300 may consist of a lower section, or neck 302, which has a through hole 305 for the channeling of sound from the speaker to the ear of the user. The gel cap 300 has a recess 306 adapted to fasten the gel cap 300 to the grip rim of the ear piece base. The neck 302 expands into an elliptical upper section 303 which may have a flared edge 310. A groove 304 is seen extending from the through hole 305 towards the raised end 307 of the gel cap 300 along the major elliptical axis. The bottom 309 of the neck may be substantially flat.

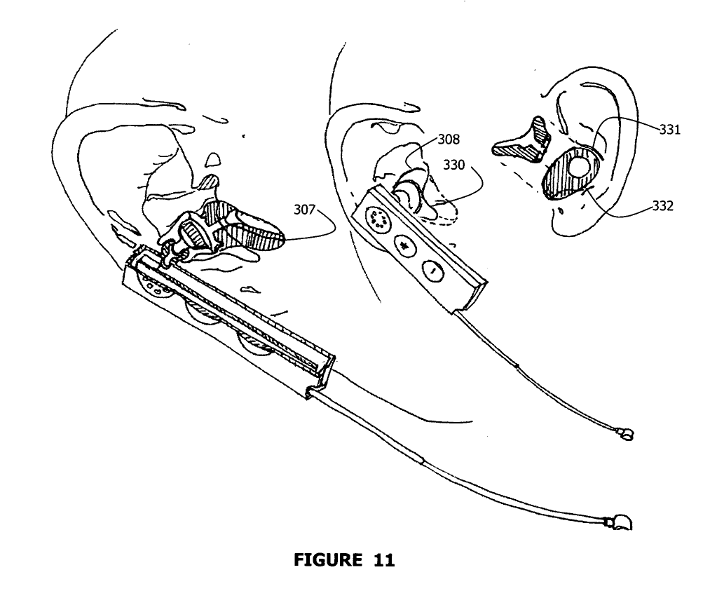

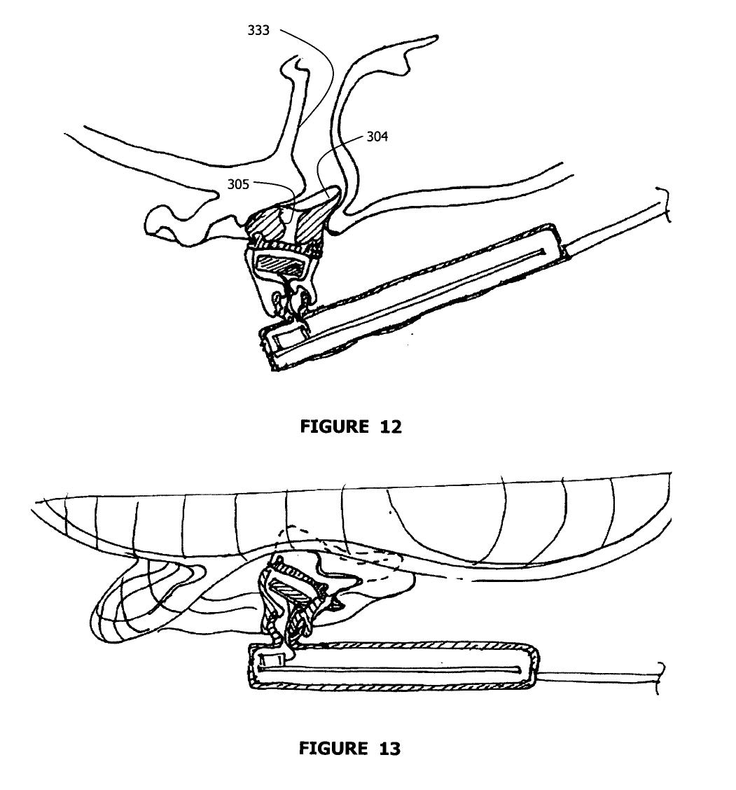

As seen in FIG. 11, the major axis of the elliptical shape 301 is aligned when in use such that one end 307 is narrowed and pointed toward the ear canal, resting under the traqus 330, and the opposite end 308 rests behind the anti-helix 331. The minor axis of the ellipse is secured between the Crus and the antitraqus 332. The crus is not labeled on the ear drawing. It is just below the crus helicus and is more or less horizontal across the mid part of the ear. The gel cap 300 is adapted to protrude into the ear canal but does not enter the ear canal and is not adapted to provide an ear seal. The groove 304 is provided in the surface of the gel cap facing the meatus extuemus and cavum conchae. The groove, which is designed in part to create a controlled sound leak, 304 is flared at its far end 312 to accommodate differing ear canal 333 locations for users of different ear geometry, and to allow the gel cap to be used in either ear. The groove and flare allow more flexibility in the channeling of sound into the ears of different users, enhancing sound transmission. In some embodiments, the through hole may be routed out to the end 307 of the gel cap within the cap itself, obviating the need for a groove.

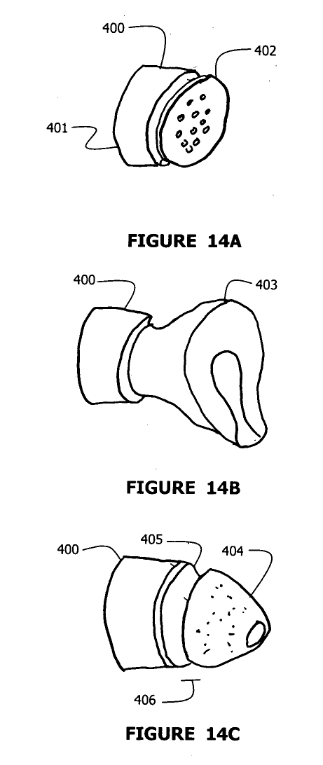

FIGS. 14A-C illustrate a speaker cap according to some embodiments of the present invention. The speaker cap 400 is adapted to provide audio signal to a user. The main body 401 of the speaker cap 400 may have a speaker or other type of audio driver or device within it. An ear piece base 402 is attached to or part of the main body 401 of the speaker cap 400. The ear piece base 402 is adapted to allow for the interchange of different ear engaging bodies with the speaker cap 400.

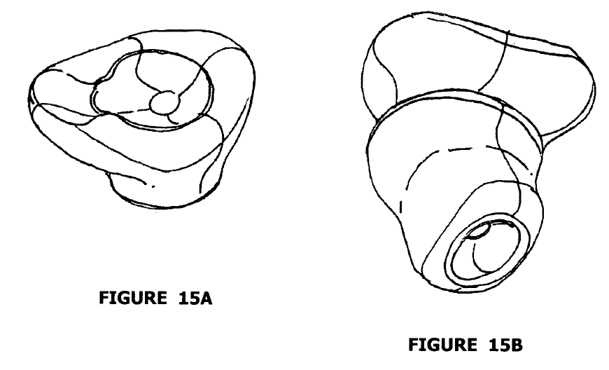

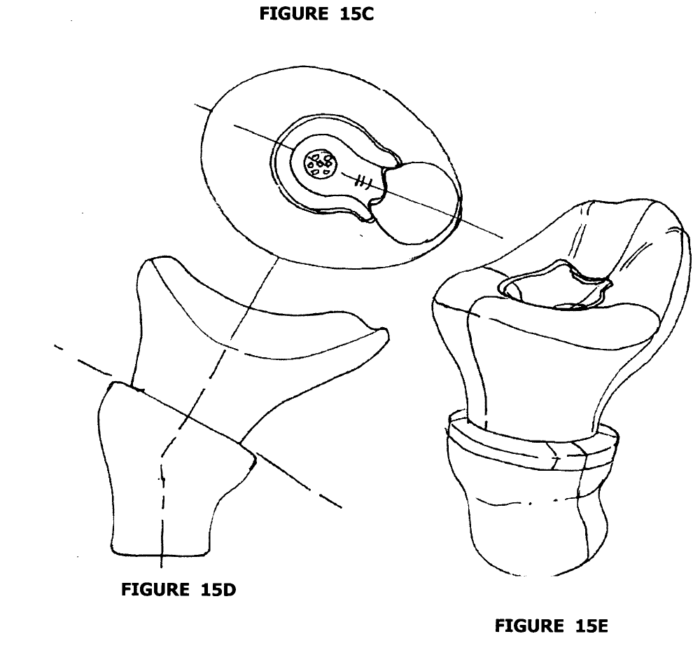

FIGS. 15A-E illustrate a two piece gel cap according to some embodiments of the present invention.

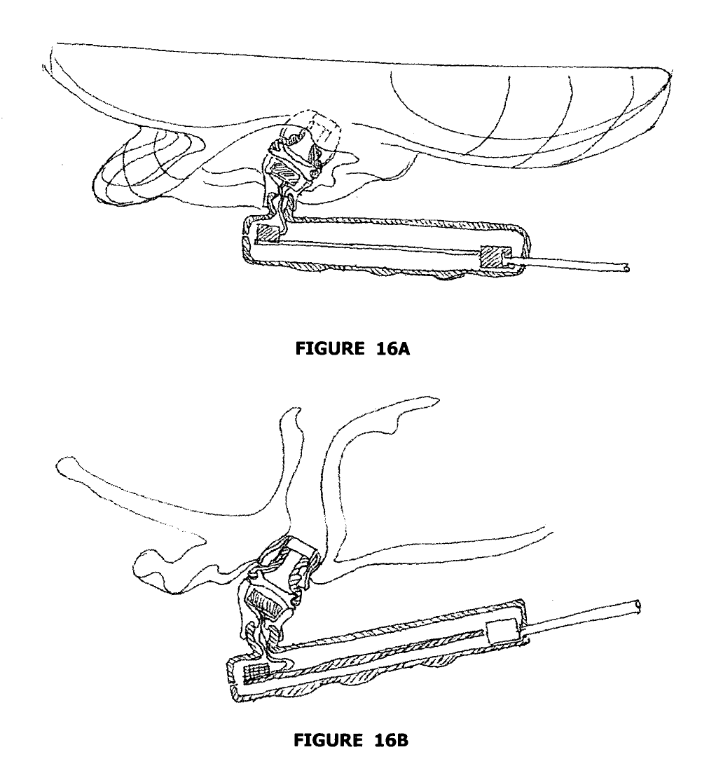

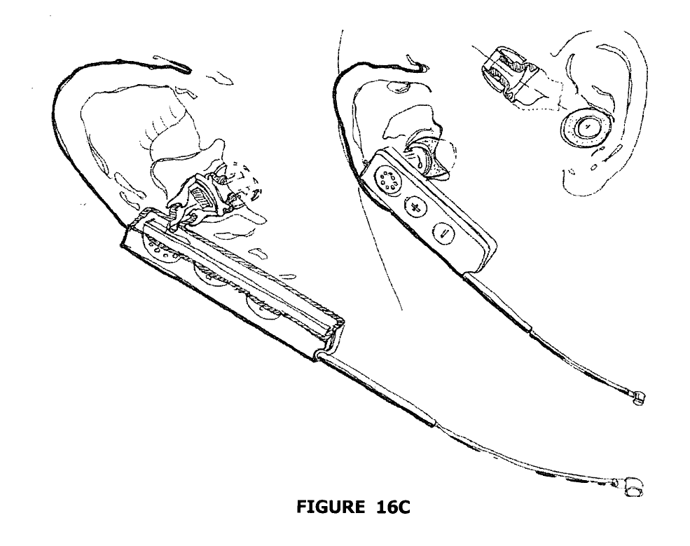

FIGS. 16 A-C illustrate a mushroom cap engaged in to the ear of a user according to some embodiments of the present invention.

In some embodiments, the speaker cap 400 may be a wireless device adapted to receive signal from another electronic device. In some embodiments, the speaker cap may have electronics within it adapted to receive a wireless signal and to route it to the enclosed speaker. In some embodiments, the speaker cap may be a wired device. The speaker cap may be wired to another electronic device, such as a wireless headset, cellular telephone, entertainment device, or another type of device.

FIGS. 14B and 14C illustrate the speaker cap 400 with differing ear engaging bodies according to some embodiments of the present invention. FIG. 14B shows a gel cap 403 attached to the speaker cap 400. The gel cap 403 is easily removable and attachable to the speaker cap 400. FIG. 14C shows a mushroom cap 406 attached to the speaker cap 400. The mushroom cap 406 may consist of a circular cap 404 and a pyramid base 405. Prior art circular type caps typically have a permanently affixed base which only allows the replacement of one type of circular cap with another, but does not allow replacement with a gel type cap as described herein.

As seen, the differing caps may be easily removed and replaced onto the speaker cap, allowing the user the flexibility of choosing which type of ear engaging body to use, depending upon personal preference or specific need, while maintaining the use of a single speaker cap.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

We claim:

1. A wireless headset comprising:
a main body;
an ear piece base, said ear piece base attached to said main body with a flexible joint; and
an easily removable and replaceable ear engaging body attached to said ear piece base.

2. The wireless headset of claim 1 wherein said flexible joint is a ball and socket type joint.

3. The wireless headset of claim of claim 1 wherein said ear piece base comprises a speaker.

4. The wireless headset of claim 1 wherein said earpiece base comprises a lip, and wherein said ear engaging body comprises a recess adapted to clip onto said lip.

5. The wireless headset of claim 4 wherein said lip is circular.

6. A kit comprising:
a wireless headset comprising:
a main body;
an ear piece base, said ear piece base attached to said main body;
a first ear engaging body, said first ear engaging body comprising a mushroom cap, said first ear engaging body adapted to substantially seal the ear canal of a user, said first ear engaging body easily attached and removed from said ear piece base; and
a second ear engaging body, said second ear engaging body comprising a gel cap, said second ear engaging body adapted to not substantially seal the ear canal of a user, said second ear engaging body easily attached and removed from said ear piece base.

7. The kit of claim 6 wherein said earpiece base comprises a lip, and wherein said first ear engaging body and said second ear engaging body comprise a recess adapted to clip onto said lip.

8. The kit of claim 7 wherein said lip is circular.

9. A gel cap comprising:
a base; and
a gel portion extending upward from said base, said gel portion comprising:
a hole up through its mid-section from said base to the top of said gel portion;
a first side extending upward a first distance; and
a second side extending upward a second distance, said second distance greater than said first distance.

10. The gel cap of claim 9 further comprising a sound channel, said sound channel in said gel portion, said sound channel running from said hole along the top of said gel portion towards said second side of said gel portion.

11. A gel cap adapted for engaging the ear of a user comprising:
an inner section of a first hardness; and
an outer section of a second hardness.

12. The gel cap of claim 11 wherein said first hardness is harder than said second hardness.

13. The gel cap of claim 12 wherein said outer section is adapted to engage the ear of a user.

14. The gel cap of claim 13 wherein said first hardness is a hardness in the range of 40-50 durometer value using a shoreA hardness scale, and wherein said second hardness is a hardness in the range of 10-25 durometer value using a shoreA hardness scale.

15. The gel cap of claim 13 wherein said inner section comprises an interior recess adapted to clip onto a lip.

16. The gel cap of claim 13 wherein said gel cap is of a material comprising a thermoplastic elastomer.

17. The gel cap of claim 12 further comprising a base adapted to snap onto a mating unit, said base comprising a recess.

18. The gel cap of claim 15 wherein said lip is circular.

19. A mushroom cap adapted for engaging the ear of a user comprising:
a pyramid base; and
a circular cap, wherein said circular cap is easily removable from said pyramid base.

20. The mushroom cap of claim 19 wherein said pyramid base is adapted to be easily attached to and removed from a headset.

21. The mushroom cap of claim 20 wherein

22. A speaker cap comprising:
a body comprising receiving electronics;
an ear piece base, said ear piece base attached to said; and
an easily removable and replaceable ear engaging body attached to said ear piece base.

23. The speaker cap of claim 22 wherein said body further comprises an audio speaker.

24. A method for replacing an ear engaging body on a wireless headset, said method comprising:
removing a first ear engaging body from an ear piece base of a headset; and
attaching a second ear engaging body to said ear piece base of the headset.

25. The method of claim 24 wherein said first ear engaging body comprises a mushroom cap, said first ear engaging body adapted to substantially seal the ear canal of a user, said first ear engaging body easily attached and removed from said ear piece base, and said second ear engaging body comprises a gel cap, said second ear engaging body adapted to not substantially seal the ear canal of a user, said second ear engaging body easily attached and removed from said ear piece base.

26. The method of claim 24 wherein said ear piece base has a lip adapted for the attachment of an ear engaging body.

27. The method of claim 26 wherein said removing a first ear engaging body comprises unsnapping said first ear engaging body from the lip of the ear piece base.

28. The method of claim 27 wherein said attaching a second ear engaging body comprises snapping said second ear engaging body to the lip of the ear piece base.

29. The method of claim 26 wherein said lip is circular.
